(19) United States
(12) Patent Application Publication
(10) Pub. No.: US 2014/0089230 A1
(43) Pub. Date: Mar. 27, 2014

(54) Mutual Fund with Reduced Fee Share Class and Method of Managing the Same

(71) Applicants: Theresa K. Kelety, Scottsdale, AZ (US); Kevin Andrew Simonoff, Atlanta, GA (US)

(72) Inventors: Theresa K. Kelety, Scottsdale, AZ (US); Kevin Andrew Simonoff, Atlanta, GA (US)

(21) Appl. No.: 14/035,565

(22) Filed: Sep. 24, 2013

Related U.S. Application Data
(60) Provisional application No. 61/706,419, filed on Sep. 27, 2012.

(51) Int. Cl. G06Q 40/06

(52) U.S. Cl. CPC G06Q 40/06
USPC 705/36 R

(57) ABSTRACT

A method of administering a mutual fund includes establishing a mutual fund having a plurality of share classes and charging each share class fund-level fees according to a fee rate applicable thereto. One or more share classes are then relieved of at least a portion of their respective fund-level fees, for example by reimbursing some or all of the fund-level fees paid; waiving payment of some or all of the fund-level fees in the first instance; and/or setting expense limits on the fund-level fees payable by the share classes.

### CROSS-REFERENCE TO RELATED APPLICATIONS

This application claims the benefit of U.S. provisional application No. 61/706,419, filed 27 Sep. 2012, which is hereby incorporated by reference as though fully set forth herein.

### BACKGROUND

The instant invention relates to mutual funds. In particular, the instant invention relates to a mutual fund that includes one or more share classes for which a fund administrator, fund advisor, or another third party bears all or some of the fees chargeable thereto.

It is known to reduce the risk of loss from investments through diversification. One common method of diversifying is to invest in mutual funds. A mutual fund is a collection of funds contributed by numerous entities (e.g., individuals, corporations, and the like), all of which have purchased shares of the fund.

Participating in a mutual fund is not costless, however. For example, there are costs associated with individual transactions (e.g., purchases and sales of shares), as well as operating costs for the fund itself (e.g., costs that are not associated with any particular transaction). Costs for the fund itself, known as fund-level fees, include, for example, advisory fees (e.g., fees associated with the management of the fund), custody fees, administrative services fees, and the like.

Typically, fund-level fees are charged to all share classes in the mutual fund at a common rate. For example, advisory fees may be charged at a rate of 100 basis points. Indeed, the Securities and Exchange Commission (“SEC”) prohibits cross-subsidization of fund-level fees between share classes. See Exemption for Open-End Management Investment Companies Issuing Multiple Classes of Shares; Disclosure by Multiple Class and Master-Feeder Funds, Investment Company Act Release No. 19955 (Dec. 15, 1993) (the “Rule 18f-3 Adopting Release”). As a result of the foregoing, certain types of investors, such as affiliated funds-of-funds, ERISA and non-ERISA institutional investors, and tax qualified and non-qualified institutional investors, are unable to invest in certain mutual funds in a cost-efficient manner, because to do so would require their investors to bear a “double layering” of fees. More particularly, the fund-level fees for the mutual fund would be stacked upon the product-level fees charged by those types of investors. For example, an advisory or administrative services fee could be charged at a collective or common trust level; charging similar fees at the underlying mutual fund level could result in a layering of fees.

Extant solutions to this problem typically fall into one of two categories. First, the asset manager can run an unregistered “pool” outside of an Investment Company Act of 1940 (“1940 Act”) fund environment. This is undesirable because, based on factors such as tax or regulatory status, it greatly limits the types of investors or situations in which the pools can be utilized. Alternatively, the asset manager can create a separate 1940 Act fund to be utilized as the pool in which investors invest. This is undesirable because, based on the available share class structure and the pricing of those classes, the type of investors or situations in which the pools can be utilized are significantly limited.

### BRIEF SUMMARY

Thus, it would be desirable to create a mutual fund that includes one or more share classes that are relieved, in whole or in part, of the fund-level fees otherwise chargeable to such share classes. This new share class can then become a “pooled” vehicle for investors that would not otherwise be able to invest in the fund in a cost-efficient manner as a result of double layering of fees.

One object disclosed herein is to provide a single vehicle for mutual funds, institutional separate accounts, collective/common trusts, and the like to get access to active management of illiquid or hard-to-access asset classes, such as emerging markets debt or bank loans. This, in turn, allows the asset manager to deliver better performance at lower cost through the enhanced scale resulting from the pooling of assets from multiple sources, many of which were previously inaccessible to the asset manager.

Another object disclosed herein is to provide customization of mandates for institutional clients at much lower asset levels than previously required, due to the availability of the pools for those illiquid or hard-to-access asset classes.

Yet another object disclosed herein is facilitating pooling by minimizing or eliminating the “double layering” of fees that would typically prevent a mutual fund, institutional separate account, collective/common trust, or the like from investing. This, in turn, allows the asset manager to customize the total pricing for that product at the investing product level.

Disclosed herein is a method of administering a mutual fund. The method includes the steps of: establishing a mutual fund having a plurality of share classes; establishing a fee rate applicable to each share class of the plurality of share classes, wherein a fund-level fee (e.g., an advisory fee, a custody fee, an administrative services fee) payable by each share class is computed according to the fee rate applicable to that share class; and relieving a selected share class of the plurality of share classes of at least a portion of the fund-level fee payable by the selected share class such that one or more service providers (e.g., fund advisors, fund administrators, affiliates of fund advisors, and/or affiliates of fund administrators) bear at least a portion of the fund-level fee payable by the selected share class. In some embodiments, a common fee rate applicable to all share classes of the plurality of share classes is employed, but it is contemplated that at least some share classes may be subject to different fee rates than others.

The selected share class of the plurality of share classes can be relieved of at least a portion of the fund-level fee payable by the selected share class by reimbursing members of the selected share class the at least a portion of the fund-level fee, by waiving payment of the at least a portion of the fund-level fee in the first instance, and/or by setting an expense limit on the fund-level fee. Of course, the relief can be total (i.e., the selected share class ultimately pays no fund-level fees) or partial (i.e., the selected share class pays a lesser amount of fund-level fees than it would otherwise pay).

In certain embodiments, multiple share classes are each relieved of at least a portion of their respective fund level fees. That is, a first selected share class can be relieved of a first portion of the fund-level fee payable by the first selected share class; while a second selected share class can be relieved of a second portion of the fund-level fee payable by the second selected share class. It is contemplated that certain share classes may be favored over others, in that they will be relieved of a greater fraction of fund-level fees.

To ensure compliance with SEC rules, which prohibit cross-subsidization, the method can also include establishing a procedure for ensuring that fees attributable to a first share class of the plurality of share classes are not charged to a second share class of the plurality of share classes.

In addition to relieving the selected share class of at least a portion of the fund-level fees, the selected share class can also be relieved of at least a portion of a class-level fee payable by the selected share class.

In another aspect, a method of managing a mutual fund includes: establishing a mutual fund, wherein the mutual fund comprises a plurality of share classes; establishing an amount of fund-level fees payable by each share class of the plurality of share classes; relieving a selected share class of the plurality of share classes of at least a portion of the amount of fund-level fees payable by the selected share class; and charging a balance of the amount of fund-level fees payable by each share class of the plurality of share classes to shareholders within such share class, and only to shareholders within such share class. Relief can be provided by charging shareholders within the selected share class the full amount of fund-level fees payable thereby and then reimbursing the portion from which they are relieved. Alternatively, payment of the portion can be waived in the first instance.

Also disclosed herein is a mutual fund including a first share class and a second share class. Shareholders of the first share class are responsible for a first portion of a fund-level fee associated with the mutual fund, while shareholders of the second share class are responsible for a second portion of the fund-level fee associated with the mutual fund. Shareholders of the first share class are also relieved of at least some of the first portion of the fund-level fee such that a service provider for the mutual fund, rather than shareholders of the second share class, bears the cost of the at least some of the first portion of the fund-level fee.

An advantage of a mutual fund according to the teachings herein is that it provides a single vehicle for multiple types of investors to access hard-to-access asset classes.

Another advantage of a mutual fund as disclosed herein is that it allows asset managers to deliver better performance at lower cost through the enhanced scale resulting from the pooling of assets from additional sources that previously could not invest in a particular fund in a cost-efficient manner.

Still another advantage of a mutual fund according to the present disclosure is that it allows customization of mandates for institutional investors at much lower asset levels than previously available.

Yet another advantage of a mutual fund as disclosed herein is that it facilitates asset pooling by reducing or eliminating the “double layering” of fees that institutional investors would otherwise confront.

The foregoing and other aspects, features, details, utilities, and advantages of the present invention will be apparent from reading the following description and claims, and from reviewing the accompanying drawings.

### DETAILED DESCRIPTION

SEC rules prohibit the cross-subsidization of fund-level fees between share classes in a mutual fund. Thus, mutual funds typically charge all share classes with advisory fees, custody fees, administrative services fees, and other fund-level funds at the same rate (e.g., 100 basis points).

The SEC, however, does not prohibit the waiver or reimbursement of expenses by a fund advisor, underwriter, or another service provider. Nor does it prohibit imposing limits on the fund-level fees payable by the shareholders. Thus, the present invention relieves one or more share classes of at least a portion of the fund-level fees payable by those share classes by reimbursing those fees, waiving payment of those fees in the first instance, and/or setting a fund-level expense limit. Consistent with SEC rules, the share class or classes that are relieved of some or all of their fund-level fees are not being cross-subsidized by any of the other share classes.

It is contemplated that certain share classes may receive a greater level of reimbursement and/or waiver than others. Thus, for a so-called “Deep Waiver Class,” the service provider can bear all or nearly all of the class's fund-level fees.

According to one aspect, a mutual fund having a plurality of share classes (e.g., Classes A, C, I, P, R, and W) is established. Each share class has associated therewith and applicable thereto a fee rate that governs the rate at which fund-level fees are charged to that class. Typically, the fund-level fee rate will be common across classes (e.g., each class has an advisory fee rate of 50 basis points). Consistent with SEC rules, however, it is contemplated that different share classes can have different “all-in” fee rates (or “expense ratios”) (e.g., certain classes can have expense ratios of 100 basis points, while others can have expense ratios of 50 basis points), particularly where different share classes incur class-specific fees, such as Rule 12b-1 fees, at different rates, and/or where certain share classes receive services of a different kind or to a different degree than other classes. For example, a fund may pay a different share of other expenses, not including advisory or custody fees, if these expenses are actually incurred in a different amount by that class, or if the class receives services of a different kind or to a different degree than other classes.

A selected share class (e.g., Class P) can then be relieved of at least a portion of the fund-level fees that would otherwise be payable by that share class. Relief can come in the form of waiver (e.g., the shareholders are not charged the fund-level fees in the first instance) and/or reimbursement of some or all of the fund-level fees that would otherwise be payable by that share class. It can also take the form of setting an expense limit on the fund-level fee payable by that share class. The end result is that one or more service providers, such as fund advisors, fund administrators, affiliates of fund advisors, and/or affiliates of fund administrators, ultimately bear at least a portion, and in some embodiments all, of the fund-level fees otherwise payable by the selected share class.

In another aspect, multiple selected share classes (e.g., Class P1 and Class P2) are each relieved of some or all of the fund-level fees that would otherwise be payable by the respective share class. One of the selected share classes (e.g., Class P1) can enjoy a greater degree of relief than another of the selected share classes (e.g., Class P2). For example, a first selected share class (e.g., Class P1) can be relieved of a first portion of the fund-level fee otherwise payable by the first selected share class, while a second selected share class (e.g., Class P2) can be relieved of a second portion of the fund-level fee otherwise payable by the second selected share class, where the first portion represents a greater fraction of the fund-level fee otherwise payable by the first selected share class than does the second portion relative to the fund-level fee otherwise payable by the second selected share class (e.g., Class P1 receives a higher percentage waiver and/or reimbursement than does Class P2). Of course, there can be more than two classes that are relieved of some or all of the fund-level fess that would otherwise be payable thereby.

### EXAMPLE

A mutual fund has six share classes: A, C, I, P, R, and W. The table below shows the fund-level expenses charged to each share class, expressed as a percentage of the value of the investment.

| | A | C | I | P | R | W |
|---|---|---|---|---|---|---|
| Management Fees | 0.55 | 0.55 | 0.55 | 0.55 | 0.55 | 0.55 |
| Distribution and/or Shareholder Services | 0.25 | 1.00 | 0 | 0 | 0.50 | 0 |
| (12b-1) Fees | | | | | | |
| Administrative Services Fees | 0.10 | 0.10 | 0.10 | 0.10 | 0.10 | 0.10 |
| Other Expenses | 0.21 | 0.21 | 0.21 | 0.21 | 0.21 | 0.21 |
| Total Annual Fund Operating Expenses | 1.11 | 1.86 | 0.86 | 0.86 | 1.36 | 0.86 |
| Waivers and Reimbursements | (0.10) | (0.10) | (0.10) | (0.75) | (0.10) | (0.10) |
| Total Annual Fund Operating Expenses | 1.01 | 1.76 | 0.76 | 0.11 | 1.26 | 0.76 |
| After Waivers and Reimbursements | | | | | | |

As can be seen from the table, the fund-level fees (e.g., management fees, administrative services fees, and other expenses) are charged at the same rate to each share class (that is, each share class has the same fee rate of 0.55% for management fees, the same free rate of 0.10% for administrative services fees, and the same fee rate of 0.21% for other expenses). As permitted under Rule 18f-3 under the 1940 Act, class-specific Rule 12b-1 fees are charged at fee rates that differ by class. In addition, Class P shares have a much greater rate of relief (e.g., rate of waivers and/or reimbursements)—0.75%, instead of the 0.10% rate on all other share classes.

Consequently, an investor in Class P shares pays a much lower percentage of his or her investment for fund-level fees than does an investor in another share class. The difference, however, is not borne by another share class, but rather by one or more service providers (e.g., the fund administrator, fund advisor, or the like).

Additional examples of the present disclosure can be found in the Class P shares of the following funds, all of which are offered by ING Funds of Scottsdale, Arizona: ING Emerging Markets Corporate Debt Fund; ING Emerging Markets Hard Currency Debt Fund; ING Emerging Markets Local Currency Debt Fund; ING Floating Rate Fund; ING High Yield Bond Fund; and ING Investment Grade Credit Fund.

Although several embodiments of this invention have been described above with a certain degree of particularity, those skilled in the art could make numerous alterations to the disclosed embodiments without departing from the spirit or scope of this invention.

For example, although the invention is described above with reference to fund-level fees, the teachings herein could be extended to other fees payable by selected share classes. The ordinarily skilled artisan will also recognize how to establish procedures to guard against prohibited cross-subsidization of fund- and class-level fees between various share classes.

Further, it should be understood that the mutual fund disclosed herein can be computer-managed. That is, one or more computing devices, including one or more processors executing computer readable program code stored on a tangible computer-readable medium, can be employed in managing the mutual fund disclosed herein.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of administering a mutual fund, comprising:
establishing a mutual fund having a plurality of share classes;
establishing a fee rate applicable to each share class of the plurality of share classes, wherein a fund-level fee payable by each share class is computed according to the fee rate applicable to that share class; and
relieving a selected share class of the plurality of share classes of at least a portion of the fund-level fee payable by the selected share class such that one or more service providers bear at least a portion of the fund-level fee payable by the selected share class.

2. The method according to claim 1, wherein establishing a fee rate applicable to each share class of the plurality of share classes comprises establishing a common fee rate for the fund-level fee, wherein the common fee rate is applicable to all share classes of the plurality of share classes.

3. The method according to claim 1, wherein relieving the selected share class of the plurality of share classes of at least a portion of the fund-level fee payable by the selected share class comprises reimbursing members of the selected share class the at least a portion of the fund-level fee.

4. The method according to claim 1, wherein relieving the selected share class of the plurality of share classes of at least a portion of the fund-level fee payable by the selected share class comprises waiving payment of the at least a portion of the fund-level fee.

5. The method according to claim 1, wherein relieving the selected share class of the plurality of share classes of at least a portion of the fund-level fee payable by the selected share class comprises setting an expense limit on the fund-level fee.

6. The method according to claim 1, wherein relieving the selected share class of the plurality of share classes of at least a portion of the fund-level fee payable by the selected share class comprises relieving the selected share class of the fund-level fee in its entirety.

7. The method according to claim 1, wherein relieving a selected share class of the plurality of share classes of at least a portion of the fund-level fee payable by the selected share class comprises:
relieving a first selected share class of a first portion of the fund-level fee payable by the first selected share class; and
relieving a second selected share class of a second portion of the fund-level fee payable by the second selected share class.

8. The method according to claim 7, wherein the ratio of the first portion to the fund-level fee payable by the first selected share class is greater than the ratio of the second portion to the fund-level fee payable by the second selected share class.

9. The method according to claim 1, wherein the fund-level fee comprises an advisory fee.

10. The method according to claim 1, wherein the fund-level fee comprises a custody fee.

11. The method according to claim 1, wherein the fund-level fee comprises an administrative services fee.

12. The method according to claim 1, further comprising establishing a procedure for ensuring that fees attributable to a first share class of the plurality of share classes are not charged to a second share class of the plurality of share classes.

13. The method according to claim 1, further comprising relieving the selected share class of at least a portion of a class-level fee payable by the selected share class.

14. The method according to claim 1, wherein the one or more service providers are selected from the group consisting of: fund advisors, fund administrators, affiliates of fund advisors, and affiliates of fund administrators.

15. A method of managing a mutual fund, comprising:
establishing a mutual fund, wherein the mutual fund comprises a plurality of share classes;
establishing an amount of fund-level fees payable by each share class of the plurality of share classes;
relieving a selected share class of the plurality of share classes of at least a portion of the amount of fund-level fees payable by the selected share class; and
charging a balance of the amount of fund-level fees payable by each share class of the plurality of share classes to shareholders within such share class, and only to shareholders within such share class.

16. The method according to claim 15, wherein relieving a selected share class of the plurality of share classes of at least a portion of the amount of fund-level fees payable by the selected share class comprises:
charging shareholders within the selected share class the amount of fund-level fees payable by the selected share class; and
reimbursing shareholders within the selected share class the at least a portion of the amount of fund-level fees payable by the selected share class.

17. The method according to claim 15, wherein relieving a selected share class of the plurality of share classes of at least a portion of the amount of fund-level fees payable by the selected share class comprises waiving payment of the at least a portion of the amount of fund-level fees payable by the selected share class in the first instance.

18. A mutual fund comprising a first share class and a second share class, wherein:
shareholders of the first share class are responsible for a first portion of a fund-level fee associated with the mutual fund;
shareholders of the second share class are responsible for a second portion of the fund-level fee associated with the mutual fund;
shareholders of the first share class are relieved of at least some of the first portion of the fund-level fee; and
a service provider for the mutual fund bears the cost of the at least some of the first portion of the fund-level fee.
